(19) United States
(12) Patent Application Publication
(10) Pub. No.: US 2008/0078629 A1
(43) Pub. Date: Apr. 3, 2008

(54) Brake force detecting device

(75) Inventors: Takehiro Horiuchi, Wako (JP); Hiromi Inagaki, Wako (JP); Takayuki Ohmori, Wako (JP); Shigehiro Yoshiuchi, Osaka (JP); Noritaka Ichinomiya, Nara (JP)

Correspondence Address: CARRIER BLACKMAN AND ASSOCIATES, 24101 NOVI ROAD, SUITE 100, NOVI, MI, 48375, US

(73) Assignees: Honda Motor Co., Ltd., Tokyo (JP); Matsushita Electric Industrial Co., Ltd., Osaka (JP)

(21) Appl. No.: 11/903,046

(22) Filed: Sep. 20, 2007

(30) Foreign Application Priority Data
Sep. 28, 2006 (JP) 2006-264023

(51) Int. Cl. F16D 66/00

(52) U.S. Cl. 188/1.11 E

(57) ABSTRACT

A brake force detecting device having a sensor plate fixed to a knuckle. A straight line connecting the centers of two bolts for fixing a caliper bracket to the knuckle is perpendicular to a straight line connecting the centers of two bolts for fixing the sensor plate to the knuckle as viewed in side elevation. A strain gauge is attached to the sensor plate.

### BACKGROUND OF THE INVENTION

1. Field of the Invention

The present invention relates to a brake force detecting device for detecting a brake force produced by a disc brake.

2. Description of the Related Art

In the case of performing braking control for a vehicle, a brake force is one of the important items of information. For example, if a brake force actually applied during braking can be detected, the condition of a road surface can be easily estimated. If the condition of a road surface can be estimated, ABS control (antiskid brake system control) can be performed more precisely, and the vehicle can therefore be braked to a halt safely in a short distance. Further, if a brake force applied to each wheel can be detected in braking during turning of the vehicle or during running on a slippery road surface having a low coefficient of friction (μ), the brake forces for all the wheels can be individually controlled to thereby allow safer running control of the vehicle.

Conventionally developed is a disc brake such that a load cell is provided on a supporting and engaging portion of a support member for friction pads or a strain gauge is attached to the supporting and engaging portion to thereby detect a brake force. A brake force measuring device including a support member for measurement of a brake force as provided between a brake caliper and a knuckle arm has been proposed in Japanese Patent Laid-open No. 6-123665. The brake force measuring device disclosed in this publication includes a support member interposed between a brake caliper and a knuckle arm and having a pair of substantially perpendicular beams and also includes detecting means for detecting displacement of the beams.

According to the brake force measuring device described in Japanese Patent Laid-open No. 6-123665, the brake force measuring device has an H-shaped cross section, so that the distance between the caliper bracket and the knuckle in the axial direction of the brake disc is large, causing an increase in size of the measuring device. Further, it is difficult to arrange a displacement detecting device between the two beams.

Further, in the brake force measuring device described in Japanese Patent Laid-open No. 6-123665, deformation due to the brake force in braking during forward running of the vehicle and deformation due to the brake force in braking during reverse running of the vehicle are generated in opposite directions. Accordingly, strain is generated both in a tensile direction and in a compressive direction, so that the zero point calibration for a sensor output is difficult, causing a problem on stabilization of a detection output.

### SUMMARY OF THE INVENTION

It is therefore an object of the present invention to provide a brake force detecting device which can suppress the influence of a vertical force and a lateral force upon the strain in a sensor plate to thereby stabilize a detection output.

In accordance with an aspect of the present invention, there is provided a brake force detecting device for a braking device including a wheel support for rotatably supporting a wheel, the wheel support being supported to a vehicle body by a suspension; a brake disc rotating with the wheel; a pair of friction pads provided on both sides of the brake disc, the friction pads being fixed to separate back plates, respectively; a brake caliper containing a pressure member for pressing the friction pads through the respective back plates against the brake disc, the pressure member being moved toward and away from the brake disc in a direction parallel to the axis of the brake disc; and a caliper bracket for supporting the friction pads through the respective back plates at opposite end portions in the circumferential direction of the brake disc and also supporting the brake caliper, the caliper bracket being fixed to the wheel support. The brake force detecting device includes a sensor plate fixed to the wheel support by means of two bolts; and strain detecting means mounted on the sensor plate; the caliper bracket being fixed to the wheel support by means of two bolts; a straight line connecting the centers of the two bolts for fixing the caliper bracket to the wheel support being perpendicular to a straight line connecting the centers of the two bolts for fixing the sensor plate to the wheel support as viewed in side elevation.

With this configuration, the sensor plate is fixed to the wheel support so that the straight line connecting the centers of the two bolts for fixing the caliper bracket to the wheel support is perpendicular to the straight line connecting the centers of the two bolts for fixing the sensor plate to the wheel support as viewed in side elevation. Accordingly, the sensor plate mainly undergoes a bending moment upon braking, and the sensor plate is deformed (strained) according to this bending moment. This strain in the sensor plate is detected by the strain detecting means, thereby allowing accurate detection of a brake force.

Preferably, the straight line connecting the centers of the two bolts for fixing the sensor plate to the wheel support passes through the center of one of the two bolts for fixing the caliper bracket to the wheel support, the one of the two bolts being located at a disc outlet position where the brake disc leaves the caliper bracket during forward running of the vehicle.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a disc brake including a brake force detecting device according to a preferred embodiment of the present invention;

FIG. 2 is a left side view of the disc brake shown in FIG. 1;

FIG. 3 is a schematic sectional view of the disc brake;

FIG. 4 is an elevational view of the brake force detecting device according to the preferred embodiment; and

FIG. 5 is a plan view of a caliper bracket in the condition where a brake caliper is removed.

### DETAILED DESCRIPTION OF THE PREFERRED EMBODIMENTS

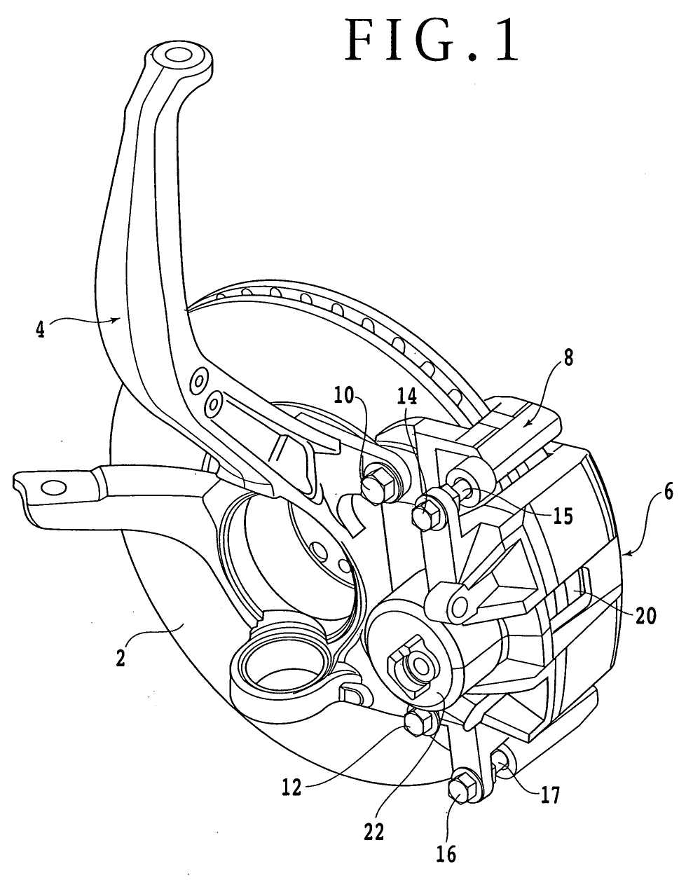

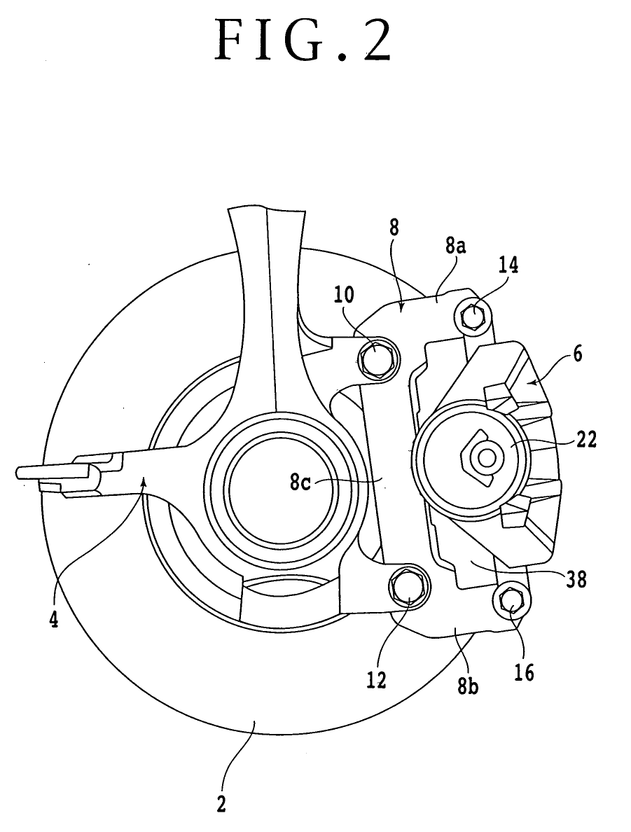

A preferred embodiment of the present invention will now be described in detail with reference to the drawings. FIG. 1 is a perspective view of a disc brake including a brake force detecting device according to a preferred embodiment of the present invention. FIG. 2 is a left side view of the disc brake shown in FIG. 1. As shown in FIGS. 1 and 2, a brake disc (disc rotor) 2 is fixed to a wheel (not shown), so that the brake disc 2 is rotated with the wheel. Reference numeral 4 denotes a knuckle (wheel support) for rotatably supporting the wheel. The knuckle 4 is connected through a suspension (not shown) to a vehicle body (not shown).

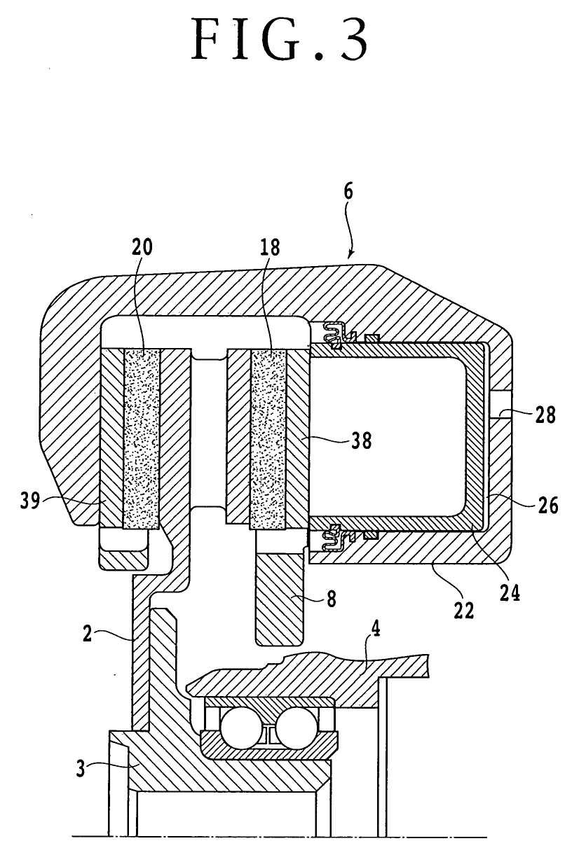

Reference numeral 8 denotes a caliper bracket, which is mounted to the knuckle 4 by two bolts 10 and 12. The caliper bracket 8 supports a pair of friction pads 18 and 20 at two opposite positions in the rotational direction (circumferential direction) of the brake disc 2, i.e., at a disc inlet position and a disc outlet position in the rotational direction of the brake disc 2. The friction pads 18 and 20 are provided on the axially opposite sides of the brake disc 2. Two slide pins 15 and 17 are slidably engaged with the caliper bracket 8. The slide pins 15 and 17 are fixed to a brake caliper 6 by two bolts 14 and 16, respectively. As shown in FIG. 3, the brake caliper 6 contains a piston (pressure member) 24 adapted to be moved toward and away from the brake disc 2 in the axial direction thereof, thereby pressing the friction pads 18 and 20 against the brake disc 2.

The brake caliper 6 has an integral wheel cylinder 22, and the piston 24 is engaged in the wheel cylinder 22. A piston chamber 26 is defined between the wheel cylinder 22 and the piston 24, and a fluid pressure is supplied from a brake master cylinder through a pressure supply port 28 into the piston chamber 26. The brake disc 2 is connected to a hub 3. When a fluid pressure is supplied from the brake master cylinder through the pressure supply port 28 into the piston chamber 26, the piston 24 is pushed leftward as viewed in FIG. 3, so that the friction pad 18 is pressed on the brake disc 2. At the same time, the brake caliper 6 is moved rightward by a reaction force resulting from the pressure of the piston 24 applied through the friction pad 18 to the brake disc 2. As a result, the friction pad 20 is pressed on the brake disc 2, thereby braking the rotation of the brake disc 2.

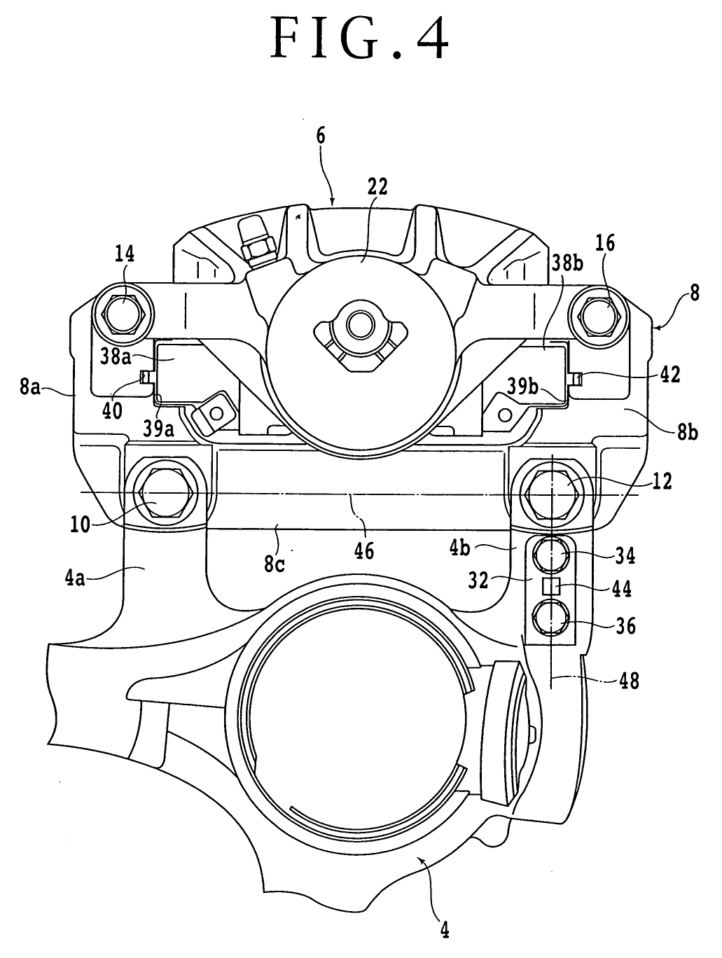

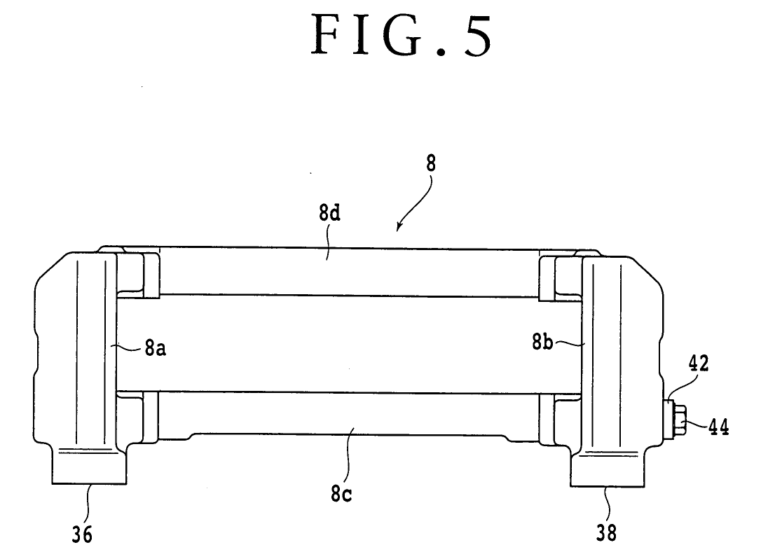

Referring to FIG. 4, there is shown an elevational view of the brake force detecting device according to the preferred embodiment of the present invention. As shown in FIG. 4, the caliper bracket 8 has a substantially U-shaped configuration as viewed in elevation such that it is composed of a pair of brake load receiving portions (brake torque receiving portions) 8a and 8b, an inner connecting portion (inner bridge portion) 8c for connecting the brake load receiving portions 8a and 8b, and an outer connecting portion (outer bridge portion) 8d (see FIG. 5) for connecting the brake load receiving portions 8a and 8b so as to extend in parallel to the inner connecting portion 8c on the axially outside thereof.

As shown in FIG. 3, the friction pad 18 is fixed to a back plate 38, and the friction pad 20 is fixed to a back plate 39. As apparent from FIG. 4, the back plate 38 has a projecting end portion 38a at the disc inlet position and a projecting end portion 38b at the disc outlet position. The brake load receiving portion 8a of the caliper bracket 8 is formed with a recess 39a adapted to engage with the projecting end portion 38a of the back plate 38. Similarly, the brake load receiving portion 8b of the caliper bracket 8 is formed with a recess 39b adapted to engage with the projecting end portion 38b of the back plate 38.

The projecting end portion 38a inserted in the recess 39a is mounted to the caliper bracket 8 by means of a pad support 40. Similarly, the projecting end portion 38b inserted in the recess 39b is mounted to the caliper bracket 8 by means of a pad support 42. The knuckle 4 has two integral arm portions 4a and 4b extending in parallel to each other. The caliper bracket 8 is fixed to these two arm portions 4a and 4b of the knuckle 4 by means of the two bolts 10 and 12 mentioned above. Preferably, the caliper bracket 8 is mounted to the knuckle 4 so that the inner connecting portion 8c of the caliper bracket 8 extends in perpendicular relationship with the arm portions 4a and 4b of the knuckle 4 as viewed in side elevation.

A sensor plate 32 is fixed to the arm portion 4b by means of two bolts 34 and 36. A strain gauge 44 is attached to the sensor plate 32. The strain gauge 44 is connected to an amplifier (not shown). This preferred embodiment is characterized in that the sensor plate 32 is mounted to the arm portion 4b of the knuckle 4 so that a straight line 46 connecting the centers of the bolts 10 and 12 is perpendicular to a straight line 48 connecting the centers of the bolts 34 and 36 as viewed in side elevation.

In the case of braking during forward running of the vehicle, the friction pads 18 and 20 come into pressure contact with the brake disc 2 during rotation of the brake disc 2, so that the friction pads 18 and 20 are dragged by the brake disc 2 to move in the rotational direction of the brake disc 2. Accordingly, the projecting end portion 38b of the back plate 38 abuts against the brake load receiving portion 8b of the caliper bracket 8. Although not shown, a similar projecting end portion of the back plate 39 abuts against the brake load receiving portion 8b of the caliper bracket 8. As a result, the brake load receiving portion 8b of the caliper bracket 8 is deformed outside in the rotational direction of the brake disc 2. At the same time, the caliper bracket 8 undergoes a bending moment in a direction perpendicular to the plane of the sheet of FIG. 4 about the point of fixation to the knuckle 4.

As mentioned above, the sensor plate 32 is mounted to the knuckle 4 so that the straight line 46 connecting the centers of the bolts 10 and 12 is perpendicular to the straight line 48 connecting the centers of the bolts 34 and 36 as viewed in side elevation. Accordingly, the sensor plate 32 undergoes a bending moment caused by the deformation of the brake load receiving portion 8b and a bending moment in a direction perpendicular to the plane of the sheet of FIG. 4.

In the case that the sensor plate 32 is mounted to the knuckle 4 so that the straight lines 46 and 48 are not perpendicular to each other as viewed in side elevation, a shearing force is applied to the sensor plate 32 due to the bending moment perpendicular to the plane of the sheet of FIG. 4. In this preferred embodiment, however, the sensor plate 32 is mounted to the knuckle 4 so that the straight lines 46 and 48 are perpendicular to each other as viewed in side elevation, so that the application of the shearing force mentioned above to the sensor plate 32 can be avoided. As a result, the sensor plate 32 undergoes only bending deformation upon braking. This bending deformation is detected by the strain gauge 44, thereby allowing accurate detection of a brake force.

While the sensor plate 32 is fixed to the arm portion 4b of the knuckle 4 near the brake load receiving portion 8b formed at the disc outlet position of the caliper bracket 8 in this preferred embodiment, the present invention is not limited to this configuration. For example, the sensor plate 32 may be fixed to any other portion of the knuckle 4 such as the arm portion 4a connected to the brake load receiving portion 8a formed at the disc inlet position of the caliper bracket 8. The strain in the sensor plate 32 is generated only when the brake torque is transmitted through the brake load receiving portion 8b of the caliper bracket 8. Accordingly, the strain in the sensor plate 32 is hardly influenced by a vertical force and a lateral force, so that the brake force can be detected accurately. As a modification, any strain detecting means other than the strain gauge 44 may be mounted on the sensor plate 32.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A brake force detecting device for a braking device including:
a wheel support for rotatably supporting a wheel, said wheel support being supported to a vehicle body by a suspension;
a brake disc rotating with said wheel;
a pair of friction pads provided on both sides of said brake disc, said friction pads being fixed to separate back plates, respectively;
a brake caliper containing a pressure member for pressing said friction pads through said respective back plates against said brake disc, said pressure member being moved toward and away from said brake disc in a direction parallel to the axis of said brake disc; and
a caliper bracket for supporting said friction pads through said respective back plates at opposite end portions in the circumferential direction of said brake disc and also supporting said brake caliper, said caliper bracket being fixed to said wheel support;
said brake force detecting device comprising:
a sensor plate fixed to said wheel support by means of two bolts; and
strain detecting means mounted on said sensor plate;
said caliper bracket being fixed to said wheel support by means of two bolts;
a straight line connecting the centers of said two bolts for fixing said caliper bracket to said wheel support being perpendicular to a straight line connecting the centers of said two bolts for fixing said sensor plate to said wheel support as viewed in side elevation.

2. The brake force detecting device according to claim 1, wherein said straight line connecting the centers of said two bolts for fixing said sensor plate to said wheel support passes through the center of one of said two bolts for fixing said caliper bracket to said wheel support, said one of said two bolts being located at a disc outlet position where said brake disc leaves said caliper bracket during forward running of the vehicle.

3. The brake force detecting device according to claim 1, wherein said pressure member includes a piston slidably fitted in a wheel cylinder, said piston being moved by supplying a fluid pressure from a master cylinder to a piston chamber.
